(19) United States
(12) Patent Application Publication
(10) Pub. No.: US 2019/0347655 A1
(43) Pub. Date: Nov. 14, 2019

(54) COMPUTER IMPLEMENTED METHOD AND SYSTEM

(71) Applicant: nChain Holdings Limited, St. John's (AG)

(72) Inventor: Martin SEWELL, London (GB)

(21) Appl. No.: 16/481,437

(22) PCT Filed: Jan. 19, 2018
(86) PCT No.: PCT/IB2018/050343

§ 371 Date: Jul. 26, 2019

(30) Foreign Application Priority Data
Jan. 27, 2017 (GB) 1701360.8

(51) Int. Cl. G06Q 20/38; H04L 9/32; H04L 9/06; G06Q 30/08

(52) U.S. Cl. CPC G06Q 20/389; H04L 9/3247; H04L 9/0643; H04L 2209/56; G06Q 20/3827; G06Q 30/08; H04L 2209/38; G06Q 20/3825

(57) ABSTRACT

A method of transferring a digital asset is disclosed. The method comprises generating first blockchain transactions (T₁), each having an output unlockable by means of a digital signature of respective buyer and a digital signature of an oracle, generating a second blockchain transaction (T₂) corresponding to each first blockchain transaction and having an input corresponding to the output of the corresponding first blockchain transaction and an output unlockable by means of the digital signature of the corresponding buyer, and generating a third blockchain transaction (T₃), corresponding to each first blockchain transaction and having an input corresponding to the output of the corresponding first blockchain transaction and an output unlockable by means of a digital signature of a seller. A first blockchain transaction is selected for signature and is signed with the digital signatures of the respective buyer and the oracle, and the corresponding third blockchain transaction is broadcast to the blockchain to enable the corresponding digital asset to be redeemed by the seller.

The present invention relates to a computer implemented system and method, and more particularly to a computer implemented system and method for transferring a digital asset. The invention is particularly suited, but not limited to, a blockchain-based auction system.

In this document we use the term ‘blockchain’ to include all forms of electronic, computer-based distributed ledgers, including, but not limited to blockchain and transaction-chain technologies, permissioned and un-permissioned ledgers, shared ledgers and variations thereof. The most widely known application of blockchain technology is the Bitcoin ledger, although other blockchain implementations have been proposed and developed. While Bitcoin may be referred to herein for the purpose of convenience and illustration, it should be noted that the invention is not limited to use with the Bitcoin blockchain and alternative blockchain implementations and protocols fall within the scope of the present invention.

A blockchain is an electronic ledger which is implemented as a computer-based decentralised, distributed system made up of blocks which in turn are made up of transactions. Each transaction includes at least one input and at least one output. Each block contains a hash of the previous block so that blocks become chained together to create a permanent, unalterable record of all transactions which have been written to the blockchain since its inception. Transactions contain small programs known as scripts embedded into their inputs and outputs, which specify how and by whom the outputs of the transactions can be accessed. On the Bitcoin platform, these scripts are written using a stack-based scripting language.

In order for a transaction to be written to the blockchain, it must be “validated”. Network nodes (miners) perform work to ensure that each transaction is valid, with invalid transactions rejected from the network. Software clients installed on the nodes perform this validation work on an unspent transaction (UTXO) by executing its locking and unlocking scripts. If execution of the locking and unlocking scripts evaluate to TRUE, the transaction is valid and the transaction is written to the blockchain. Thus, in order for a transaction to be written to the blockchain, it must be i) validated by the first node that receives the transaction—if the transaction is validated, the node relays it to the other nodes in the network; and ii) added to a new block built by a miner; and iii) mined, i.e. added to the public ledger of past transactions.

Although blockchain technology is most widely known for the use of cryptocurrency implementation, digital entrepreneurs have begun exploring the use of both the cryptographic security system Bitcoin is based on and the data that can be stored on the Blockchain to implement new systems. It would be highly advantageous if the blockchain could be used for automated tasks and processes which are not limited to the realm of cryptocurrency. Such solutions would be able to harness the benefits of the blockchain (e.g. a permanent, tamper proof records of events, distributed processing, etc.) while being more versatile in their applications.

One area of current research is the use of the blockchain for the implementation of “smart contracts”. These are computer programs designed to automate the execution of the terms of a machine-readable contract or agreement. Unlike a traditional contract which would be written in natural language, a smart contract is a machine executable program which comprises rules that can process inputs in order to produce results, which can then cause actions to be performed dependent upon those results.

Another area of blockchain-related interest is the use of ‘tokens’ (or ‘coloured coins’) to represent and transfer real-world entities via the blockchain. A potentially sensitive or secret item can be represented by the token which has no discernible meaning or value. The token thus serves as an identifier that allows the real-world item to be referenced from the blockchain.

A further area of interest is in the setting up of markets to enable blockchain-based trading of commodities. When commodities are to be traded, there are incentives to enable buyers and sellers to discover information and carry out a voluntary exchange more efficiently, i.e. to develop a market.

Trading in goods and services is usually carried out by means of an auction in which goods or services are offered for bid, bids are taken, and then the goods or services are sold to a selected bidder.

Attempts to automate an auction process suffer from the drawback that a trusted third party is required to receive bids, and if the security of the trusted third party is compromised, sensitive data relating to the bidders could also be compromised. In addition, an undesirable level of trust may need to be placed with the third party.

Preferred embodiments of the present invention seek to overcome one or more of the above disadvantages of the prior art.

According to an aspect of the present invention, there is provided a method of transferring a digital asset, the method comprising:

generating a plurality of first blockchain transactions, wherein each said first blockchain transaction has an output unlockable by means of a digital signature of a respective first user and a digital signature of a second user to redeem a respective digital asset;

generating a respective second blockchain transaction, corresponding to each said first blockchain transaction, wherein each said second blockchain transaction has an input corresponding to the output of the corresponding said first blockchain transaction and has an output unlockable by means of said digital signature of the corresponding said first user to redeem the corresponding said digital asset;

generating a respective third blockchain transaction, corresponding to each said first blockchain transaction, wherein each said third blockchain transaction has an input corresponding to the output of the corresponding said first blockchain transaction and has an output unlockable by means of a digital signature of a third user to redeem the corresponding said digital asset;

selecting a said first blockchain transaction for signature; and

signing said output of said selected first blockchain transaction with said digital signatures of said first and second users, and broadcasting the corresponding said third blockchain transaction to the blockchain to enable the corresponding said digital asset to be redeemed by said third user.

Implementing the transfer of a digital asset by means of blockchain transactions provides a number of advantages. Firstly, the distributed nature of the blockchain provides the advantage of enhanced security and reliability. However, the fact that the blockchain is stored as validated blocks on a number of nodes means that the circumstances of the selection of a particular first blockchain transaction for signature can be investigated in the case of a dispute. The advantage is also provided that by signing the output of a selected first blockchain transaction, for example in the case of a successful bid in an auction, and broadcasting the corresponding said third blockchain transaction to the blockchain, the unselected first blockchain transactions, i.e. representing unsuccessful bids, become automatically invalid and are not propagated by the blockchain, therefore reducing the amount of processing required for and memory occupied by those transactions. In addition, because the second user receives unsigned blockchain transactions, the amount of trust needed to be placed in the second user is minimised, since the corresponding digital assets cannot be redeemed without the signature of the respective first user.

Each said second blockchain transaction may be ineffective before a predetermined time.

This provides the advantage of preventing bids from being refunded, in the case of an auction, until the auction process has been completed.

Selection of a said first blockchain transaction may occur while said second blockchain transactions are ineffective.

This provides the advantage of preventing refund of a successful bid, thereby improving the security of operation of the method.

The method may further comprise automatically selecting a said first blockchain transaction for signature.

This provides the advantage of enabling the process to be automated so that a first blockchain transaction is selected for signature when certain conditions are met.

The output of each first said blockchain transaction may be a pay to script hash (P2SH) transaction.

This provides the advantage of requiring less processing and occupying less memory in the blockchain.

The method may further comprise signing each said second blockchain transaction with said digital signature of said second user to enable the respective digital asset to be redeemed by the corresponding said first user.

The method may further comprise broadcasting said second blockchain transactions to the blockchain.

The digital asset may be a bid in an auction process.

The method may further comprise sending each said first blockchain transaction to said second user to enable signature of said output of said selected first blockchain transaction by said second user.

The method may further comprise sending each said second blockchain transaction to said second user to enable signature of said output of said second blockchain transaction by said second user.

The method may further comprise sending said selected first blockchain transaction to said first user to enable signature of said output of said first blockchain transaction by said first user and broadcast of said selected first blockchain transaction to the blockchain.

The second user may select a said first blockchain transaction for signature on the basis of external information.

This provides the advantage of enabling the second user to act as a trusted third party and to make the selection on the basis of verifiable information (such as market conditions or prices).

According to another aspect of the present invention, there is provided a system for carrying out the method defined above.

A preferred embodiment of the invention will now be described, by way of example only and not in any limitative sense, with reference to the accompanying drawings in which:

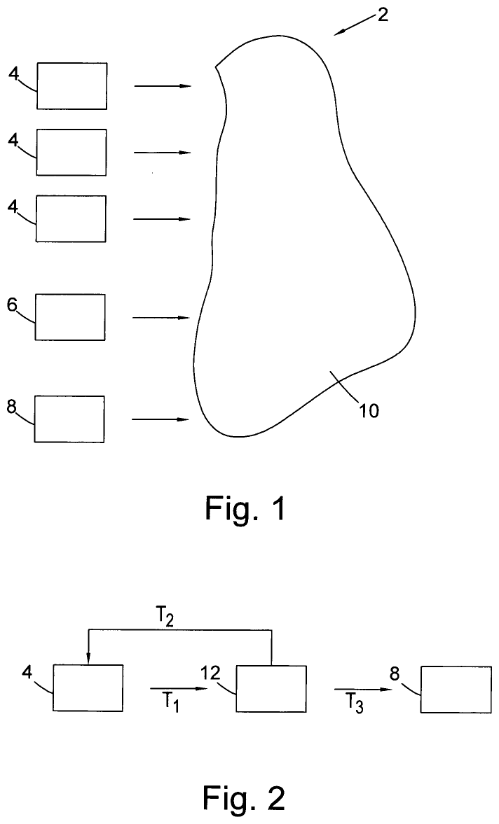

FIG. 1 is a schematic representation of a system for implementing a blockchain-based auction embodying the present invention; and

FIG. 2 illustrates blockchain transaction flow of the system of FIG. 1.

Referring to FIG. 1, a blockchain-based auction system 2 has a series of first users in the form of buyers 4, a second user in the form of a trusted third party server (for example, in the form of a node on the network) known as an oracle 6, and a third user in the form of a seller 8. The users 4, 6, 8 communicate with each other over the internet 10 by means of blockchain transactions.

In order to implement the auction of the invention, the buyers 4, oracle 6 and seller 8 download and install client software. The seller 8 then creates a product listing on its computer and publishes it by sending it out to a distributed peer-to-peer network of other people who have also installed the software. An auction-style listing is created, and an expiry date and time, and a hidden reserve price if required, are added for the product listing.

At the same time, the buyers 4 use the client software to search for items and each buyer 4 can bid for an item subject to auction. In order to do this, each buyer 4 creates a first blockchain transaction T₁ having a 2-of-2 P2SH multisig output, sending the amount of bitcoin to be bid, n, plus two Bitcoin transaction fees, from the individual buyer 4 to an address that must be signed by the buyer 4 and the oracle 6. In the case of a buyer Bob and seller Alice, the first blockchain transaction T₁ is shown in table 1, and its redeem script is shown in table 2.

TABLE 1
Bitcoin transaction T₁

| Version number | | | |
|---|---|---|---|
| Number of inputs | | | 1 |
| Input | Previous | Hash | T_{θ} |
| (unlocking) | transaction | Output index | |

| | Length of signature script | |
|---|---|---|
| | Signature script [P2PKH] | <Bob's signature> <Bob's public key> |
| | Sequence number | |
| Number of outputs | | 1 |
| Output | Value | n + 2 × Bitcoin transaction fee |
| (locking) | Length of public key script | |
| | Public key script [P2SH multisig] | OP_HASH16θ <hash16θ(redeem script)> OP_EQUAL |

| | |
|---|---|
| Locktime | 0 |

TABLE 2
Redeem script for transaction T₁

| | |
|---|---|
| Redeem script [P2SH multisig] | OP_2<Bob's public key> <oracle's public key> OP_2 |
| | OP_CHECKMULTISIG |

At the same time, each buyer 4 (Bob, in the above example) also creates a provisional return payment bitcoin transaction T₂, which spends the output from T₁ back to the respective buyer 4 Bob with an output n plus the Bitcoin transaction fee and a locktime set to the end of the auction, t. Transaction T₂ is shown in Table 3 below. Each buyer 4 signs its own input script and sends the incomplete transaction to the oracle 6, which then presents the signature to the input script, thereby making it a valid transaction, except for the locktime, and returns it to the respective buyer 4.

TABLE 3
Bitcoin transaction T₂

| Version number | | | |
|---|---|---|---|
| Number of inputs | | | 1 |
| Input | Previous | Hash | T₁ |
| (unlocking) | Transaction | Output index | θ |

| | Length of signature script | |
|---|---|---|
| | Signature script [P2SH multisig] | OP_θ <Bob's signature> <oracle's signature> |
| | | <redeem script> |
| | Sequence number | |
| Number of outputs | | 1 |
| Output | Value | n + Bitcoin transaction fee |
| (locking) | Length of public key script | |
| | Public key script [P2PKH] | OP_DUP OP_HASH16θ <hash16θ(Bob's public |
| | | key)> OP_EQUALVERIFY OP_CHECKSIG |

| | |
|---|---|
| Locktime | t |

Finally, each buyer 4 creates a bitcoin transaction T₃, spending the output from T₁ and enabling the bitcoins to be sent to the seller 8 (Alice in the above example), as shown in Table 4, by means of an output n plus the Bitcoin transaction fee. The buyer 4 then sends the unsigned transaction T₃ to the oracle 6, who collates all of the bid transactions for a particular item, and only signs the transaction with the winning bid, which may be selected on the basis of the highest bid, or according to some other condition. In the case of equally valid bids, the reputation of the bidder, or a first bid first served system may be implemented.

The transaction T₃ corresponding to the winning bid is then returned to the respective buyer 4 to be signed and broadcast to the blockchain, as a result of which the seller 8 receives the payment and dispatches the goods being bid for to the buyer 4 with the winning bid. The other buyers broadcast their respective transactions T₂, thereby returning the bitcoins being bid to an address under the sole control of the respective buyer 4. The trust placed in the oracle 6 is kept to a minimum, since the bidders 4 send their transactions to the oracle 6 unsigned, and the bidder 4 has the final say. This flow of transactions is shown in FIG. 2.

TABLE 4
Bitcoin transaction T₃

| Version number | | | |
|---|---|---|---|
| Number of inputs | | | 1 |
| Input | Previous | Hash | T₁ |
| (unlocking) | Transaction | Output index | θ |

| | Length of signature script | |
|---|---|---|
| | Signature script [P2SH multisig] | OP_θ <Bob's signature> <oracle's signature> |
| | | <redeem script> |
| | Sequence number | |
| Number of outputs | | 1 |
| Output | Value | n + Bitcoin transaction fee |
| (locking) | Length of public key script | |
| | Public key script [P2PKH] | OP_DUP OP_HASH16θ <hash16θ(Alice's public |
| | | key)> OP_EQUALVERIFY OP_CHECKSIG |

| | |
|---|---|
| Locktime | 0 |

Finally, the links between the various transactions are shown in table 5, from which it can be seen that all of the transactions are standard P2PKH or P2SH multisig, and validate.

TABLE 5
Transaction linkage

| | Locking | | | Unlocking | |
|---|---|---|---|---|---|
| | Txid | Pubkey script | Redeem script | Txid | Signature script |
| P2PKH | T₀ | | | T₁ | <Bob's signature> <Bob's |
| | | | | | public key> |
| P2SH | T₁ | OP_HASH16θ | OP_2 <Bob's public | T₂ | OP_θ <Bob's signature> |
| multisig | | <hash16θ(redeem | key> <oracle's | | <oracle's signature> |
| | | script)> OP_EQUAL | public key> OP_2 | | <redeem script> |
| | | | OP_CHECKMULTISIG | | |
| P2SH | T₁ | OP_HASH16θ | OP_2 <Bob's public | T₃ | OP_θ <Bob's signature> |
| multisig | | <hash16θ(redeem | key> <oracle's | | <oracle's signature> |
| | | script)> OP_EQUAL | public key> OP_2 | | <redeem script> |
| | | | OP_CHECKMULTISIG | | |
| P2PKH | T₂ | OP_DUP OP_HASH16θ | | | |
| | | <hash16θ(Bob's | | | |
| | | public key)> | | | |
| | | OP_EQUALVERIFY | | | |
| | | OP_CHECKSIG | | | |
| P2PKH | T₃ | OP_DUP OP_HASH16θ | | | |
| | | <hash16θ(Alice's | | | |
| | | public key)> | | | |
| | | OP_EQUALVERIFY | | | |
| | | OP_CHECKSIG | | | |

It will be appreciated by persons skilled in the art that the above embodiment has been described by way of example only and not in any limitative sense, and that various alterations and modifications are possible without departure from the scope of the invention as defined by the appended claims.

1. A method of transferring a digital asset, the method comprising:
generating a plurality of first blockchain transactions, wherein each said first blockchain transaction has an output unlockable by means of a digital signature of a respective first user and a digital signature of a second user to redeem a respective digital asset;
generating a respective second blockchain transaction, corresponding to each said first blockchain transaction, wherein each said second blockchain transaction has an input corresponding to the output of the corresponding said first blockchain transaction and has an output unlockable by means of said digital signature of the corresponding said first user to redeem the corresponding said digital asset;
generating a respective third blockchain transaction, corresponding to each said first blockchain transaction, wherein each said third blockchain transaction has an input corresponding to the output of the corresponding said first blockchain transaction and has an output unlockable by means of a digital signature of a third user to redeem the corresponding said digital asset;
selecting a said first blockchain transaction for signature; and
signing said output of said selected first blockchain transaction with said digital signatures of said first and second users, and broadcasting the corresponding said third blockchain transaction to a blockchain to enable the corresponding said digital asset to be redeemed by said third user.

2. A method according to claim 1, wherein each said second blockchain transaction is ineffective before a predetermined time.

3. A method according to claim 2, wherein selection of a said first blockchain transaction occurs while said second blockchain transactions are ineffective.

4. A method according to claim 1, further comprising automatically selecting a said first blockchain transaction for signature.

5. A method according to claim 1, wherein the output of each first said blockchain transaction is a pay to script hash (P2SH) transaction.

6. A method according to claim 1, further comprising signing each said second blockchain transaction with said digital signature of said second user to enable the respective digital asset to be redeemed by the corresponding said first user.

7. A method according to claim 1, further comprising broadcasting said second blockchain transactions to the blockchain.

8. A method according to claim 1, wherein the digital asset is a bid in an auction process.

9. A method according to claim 1, further comprising sending each said first blockchain transaction to said second user to enable signature of said output of said selected first blockchain transaction by said second user.

10. A method according to claim 1, further comprising sending each said second blockchain transaction to said second user to enable signature of said output of said second blockchain transaction by said second user.

11. A method according to claim 1, further comprising sending said selected first blockchain transaction to said first user to enable signature of said output of said first blockchain transaction by said first user and broadcast of said selected first blockchain transaction to the blockchain.

12. A method according to claim 1 wherein the second user selects said first blockchain transaction for signature on the basis of external information.

13. A system for carrying out a method according to claim 1.
